(19) United States
(12) Patent Application Publication
(10) Pub. No.: US 2009/0228136 A1
(43) Pub. Date: Sep. 10, 2009

(54) Method and Device for Guiding a Machine Part Along a Defined Motion Path Over a Workpiece Surface

(76) Inventors: Guenter Grupp, Boehmenkirch (DE); Ernst Stumpp, Koenigsbronn (DE); Otto Boucky, Heidenheim (DE); Joerg Walther, Gerstetten (DE)

Correspondence Address: HARNESS, DICKEY & PIERCE, P.L.C., P.O. BOX 828, BLOOMFIELD HILLS, MI, 48303, US

(21) Appl. No.: 11/990,229

(22) PCT Filed: Jul. 20, 2006
(86) PCT No.: PCT/EP2006/007130

§ 371 Date: Dec. 29, 2008

(30) Foreign Application Priority Data
Aug. 8, 2005 (DE) 10-2005-039-094.3

(51) Int. Cl. G05B 19/19

(52) U.S. Cl. 700/173

(57) ABSTRACT

A machine part (12) is guided along a defined movement path (28) over a workpiece surface (23). The machine part (12) is held at a defined distance (50) from the workpiece surface (23) during this movement. For that purpose, a distance sensor (14) is provided that runs ahead of the machine part (12) with a defined lead (18). A plurality of distance values between the distance sensor (14) and the workpiece surface (23) are determined. A plurality of control values for adjusting the defined distance (50) are determined as a function of the distance values. The defined distance (50) is repeatedly adjusted by means of the control values. In accordance with one aspect of the invention, the distance values along the movement path (28) are determined by means of a first grid spacing (46). The control values are determined along the movement path (28) with a second grid spacing (44). The first and the second grid spacings (46, 44) are different.

The present invention relates to a method for guiding a machine part along a defined movement path over a workpiece surface, with the machine part being held along the movement path at a defined distance from the workpiece surface, comprising the steps of:
providing a distance sensor that runs ahead of the machine part along the movement path with a defined lead,
determining a plurality of distance values between the distance sensor and the workpiece surface along the movement path,
determining a plurality of control values for adjusting the defined distance as a function of the first distance values,
moving the machine part along the movement path and repeatedly adjusting the defined distance by means of control values.

The invention further relates to an arrangement for guiding a machine part along a defined movement path over a workpiece surface, wherein the machine part is configured to be held at a defined distance from the workpiece surface along the movement path, comprising:
at least one distance sensor configured to run ahead of the machine part along the movement path with a defined lead, the at least one distance sensor being designed for determining a plurality of distance values between the distance sensor and the workpiece surface along the movement path,
a control unit designed for determining a plurality of control values for adjusting the defined distance as a function of the first distance values, and
a first drive unit for moving the machine part along the movement path, and a second drive unit for repeatedly adjusting the defined distance by means of the control values.

Such a method and such an arrangement are disclosed by DE 33 41 964 A1.

This publication discloses an arrangement that has a welding head which serves for welding two plates to one another along an abutting edge. A distance sensor runs ahead of the welding head with a constant lead. The distance sensor serves the purpose of determining the course of the abutting edge and the height of the welding head above the surface of the two plates such that the welding head can be guided exactly over the course of the abutting edge. A control circuit for the welding head includes a delay and correction stage that is fed by the output signals of the distance sensor running ahead. The distance sensor is controlled via actuators to the desired height position and lateral position relative to the abutting edge. The delay and correction stage passes the corresponding control signals on to the actuators for the welding head in a fashion delayed by the lead. The aim of the time delay is to ensure that the welding head assumes at every instant exactly that position which the distance sensor had assumed earlier by the delay time. Since the distance sensor maintains a desired position above the abutting edge owing to the self regulation, the welding torch follows the desired path.

The known approach has the disadvantage that both the distance sensor and the welding head require drive elements, since the distance sensor is controlled independently of the movement of the welding head. The high number of actuators renders this approach expensive. Moreover, the accuracy with which the welding head follows the distance sensor is limited by the tolerances of the individual actuators. The welding head can follow the self-regulation of the distance sensor only to the extent that the actuators of the welding torch correspond to the actuators of the distance sensor. The known approach is particularly complicated and disadvantageous when, instead of guiding a welding head with a largely punctiform effective range, the aim is to guide on the workpiece surface a machine part that has a linear range of activity on the workpiece surface.

DE 196 15 069 A1 also discloses an arrangement and a method for guiding a tool at a defined distance above a workpiece surface. In an exemplary embodiment, two plates of different size lying on one another are to be welded along the terminating edge of the smaller plate. In this case, the welding head follows a sensing element which acquires the course of the edge in a tactile manner. A control arrangement ensures that the welding head follows the course of the edge, wherein the height position of the welding head above the workpiece surface is also tracked. In contrast to the arrangement of DE 33 41 964 A1, the welding head is here rigidly coupled to the distance sensor. Accordingly, fewer actuators are required. However, the known solution requires an accurately preprogrammed movement path, since the sensing element acquires only a deviation from such a preprogrammed movement path. Moreover, the focus control is exact only for the sensing element, but not for the welding head running behind.

There are a plurality of other proposals for guiding a machine part at a defined distance above a workpiece surface. A number of running wheels are arranged on the machine part (a laser processing head) according to DE 299 04 097 U1. The running wheels should be positioned as near as possible to the weld seam of the workpiece to be processed, but this is problematic in the case of welding operations and/or in the case of sensitive surfaces.

In DE 32 43 341 A1 it is proposed to take a photograph with a camera of a slot pattern projected onto the workpiece surface. EP 0 554 523 B1 (=DE 692 19 101 T2) proposes to evaluate the color spectrum in the region of a weld seam, with the welding head likewise being guided on the workpiece surface via rollers. DE 195 16 376 A1 proposes to evaluate the intensity of a laser induced plasma by means of a detector that looks obliquely on to the course of a laser weld seam. All these proposals require complicated signal processing to determine distance.

Other proposals use a capacitive sensor which should be seated as close as possible on or at the guided machine part (EP 0 743 130 B1, DE 197 27 094 C2, DE 91 17 180 U1, DD 286 887 A5). These proposals attempt to avoid a lead (or spacing) of the distance sensor in front of the guided machine part, or they neglect such a lead.

DE 37 30 709 A1 discloses to guide a distance sensor over a workpiece surface which is to be processed in a first operating mode, and to undertake the actual processing operation later in a second operating mode, wherein the measured values from the first pass are used during the second pass for distance control. This approach is time consuming, because the machine part must be guided at least twice over the workpiece surface.

In addition, it is common to all known approaches that the range of activity of the controlled machine part on the workpiece surface is substantially punctiform. No focus control is provided for a linear range of activity.

Against this background, it is an object of the present invention to provide an alternative that enables simple and cost-effective focus control on a workpiece surface. Preferably, the new approach should allow a simple and cost-effective application in the case of machine parts having a linear range of activity.

According to one aspect of the invention, this object is achieved by a method of the type mentioned at the beginning wherein the distance values are determined at a plurality of measurement positions that are distributed along the movement path with a first grid spacing, and wherein the control values are assigned to a plurality of actuating positions that are distributed along the movement path with a second grid spacing, with the first and the second grid spacing being different.

According to another aspect of the invention, this object is achieved by an arrangement of the type mentioned in the beginning wherein the at least one distance sensor is designed for determining the distance values at a plurality of measurement positions that are distributed along the movement path with a first grid spacing, and wherein the control unit is designed for assigning the control values to a plurality of actuating positions that are distributed along the movement path with a second grid spacing, with the first and second grid spacings being different.

The novel method and the novel arrangement thus use at least one distance sensor running ahead, as it is known from DE 33 41 964 A1 mentioned at the beginning. Consequently, the novel method and the novel arrangement are independent of the technology of the distance sensor used. In principle, it is possible to use any sensor that is capable of supplying a signal by means of which the distance between the machine part and the workpiece surface can be determined. Because of the great variety in the selection of a suitable distance sensor, the novel method and the novel arrangement can be implemented very cost-effectively. Because of the lead, the distance sensors can further be very well protected against interference and damage by the machine part running behind. Since the distance sensor requires no “visual contact” with the processing site on the workpiece surface, shielding plates can be used for decoupling.

The novel method and the novel arrangement enable the at least one distance sensor and the machine part to be rigidly connected to one another. Consequently, the number of drive elements required can be reduced compared to the solution from DE 33 41 964 A1. Moreover, tracking errors that are caused by tolerance deviations in separate drive elements are avoided. The novel method and the novel arrangement therefore enable cost-effective guidance of the machine part with high accuracy. On the other hand, parallax errors owing to tracking of the machine part can be effectively corrected or avoided.

Moreover, the novel method and the novel arrangement have the advantage that the steps of recording of measured values (determination of the actual state) and adjusting the defined distance are decoupled as a result of the different grid spacings. It is therefore easily possible to measure and to average a number of distance values for one actuating position. This enables a very smooth and accurate control response since short period fluctuations are ignored. Conversely, very high movement speeds can be achieved in the case of a flat workpiece surface, because adjusting the defined distance is not “unnecessarily” held up by numerous distance measurements in this case.

Finally, the recording of distance values and the adjusting of the defined distance by means of mutually independent grid spacings enable a very simple implementation when a linear or even two-dimensional range of activity is to be optimally set on the workpiece surface, as is illustrated below by means of preferred exemplary embodiments.

The above object is therefore completely achieved.

In a preferred refinement of the invention, the first grid spacing is smaller than the second grid spacing.

In this refinement, the distance values are determined with a higher frequency or density than the control values for adjusting the defined distance. This enables the obtained distance values to be selected, checked for plausibility and preferably averaged. This renders the control response smoother. Moreover, the novel method and the novel arrangement of this refinement are less sensitive to stochastic interference that influences the measurement of the distance values. Consequently, it is possible to achieve a particularly high accuracy of the focus control with this refinement.

In a further refinement, the first grid spacing is greater than the second grid spacing. This refinement permits very high feed rates, and it is particularly preferred when the workpiece surface is very flat. Since use is made of more control values in this refinement than measured distance values are available (the density of the control values is higher than the density of the distance values), it is preferred to determine control values without an “assigned” distance value as a function of interpolated distance values. Because of the distance sensor running ahead, it is possible to interpolate by using “future” distance values in this case, that is to say by using distance values of a measurement position that the machine part has not yet reached. Consequently, this refinement enables the defined distance to be accurately observed despite the reduced measurement outlay.

In a further refinement, each distance value is assigned to that actuating position which lies nearest the measurement position of the distance value.

As an alternative, “redundant” distance values could be discarded or serve merely for a plausibility check. However, a more uniform and more accurate control response is achieved if each distance value is assigned to an actuating position and features in the determination of the control value.

In a further refinement, a number of distance values are determined for each actuating position.

This refinement likewise contributes to a more uniform and more accurate control response since each control value is a function of a number of measured distance values here. Erroneous measurements and/or interference in the measurement sequence are more effectively suppressed.

In a further refinement, a number of distance values are averaged for one actuating position in order to determine the control value for said one actuating position.

As already explained further above, this refinement is a simple and effective possibility of achieving a smooth and accurate control response.

In a further refinement, the control values are provided in a rolling memory. The memory positions in the rolling memory preferably correspond to the actuating positions in the second grid spacing, that is to say a memory entry is provided for each actuating position.

The use of a rolling memory is a very simple and cost-effective possibility of managing the actuating values from the lead of the at least one distance sensor. In particular, this refinement permits the use of a very small memory with a number of memory positions that is equal to or only slightly greater than the number of the control values that must be buffered on the basis of the lead of the at least one distance sensor.

In a further refinement, the control values for adjusting the distance are fed to a controller that has a progressive controller gain.

In this refinement, the controller has a nonlinear controller gain that rises disproportionately in the case of high system deviations. It is preferable for the controller not to react at all in the event of small system deviations, that is to say the controller gain vanishes below a defined threshold value.

The control operation can be accelerated by means of this refinement, that is to say the defined distance is adjusted more quickly to the desired range in the event of relatively high system deviations. On the other hand, the introduction of “fuzziness” in the event of slight system deviations leads to a smoother response. This enables a higher processing quality.

In a further refinement, the control values are provided in a memory, and at least two control values of different actuating positions are combined by means of an FIR filter in order to determine a filtered control value. It is particularly preferred when the combination by means of the FIR filter is not performed until the machine part is adjusted, or in other words, upon or after the control values are read out of the memory. Furthermore, it is preferred when at least one of the control values used is a “future” control value, that is to say a control value relating to an actuating position that the machine part running behind has not yet reached.

This refinement enables a particularly smooth and accurate control response. It utilizes an advantage enabled by the distance sensor running ahead, because “future” distance values can be incorporated in the filtering. It is thereby possible to implement a filter that is true to phase in online operation. It is particularly preferred to undertake the combination of the at least two control values when the control values are read out of the memory, because then a maximum number of “future” distance values can be considered.

In a further refinement, the machine part has a linear range of activity on the workpiece surface, which range of activity runs transverse to the movement path.

This refinement is directed to a preferred application of the present invention, where a workpiece surface is scanned with a linear band of light and/or heated. Such an application raises the challenge of keeping not only a point on the workpiece surface in focus but an extended geometric figure. In order to achieve an optimum focus control here, it is necessary to keep the distances along the linear range of activity in the focus of the machine part, which is not possible with the known approaches or only with s great outlay. The present invention enables a simple focus control for the linear range of activity, as is illustrated below with respect to a preferred exemplary embodiment.

In a further refinement, at least two distance sensors are provided that each run ahead of the linear range of activity with a defined lead.

This refinement is a particularly simple and cost-effective possibility of keeping the linear range of activity in focus. In particular, it enables the use of simple distance sensors that measure in punctiform fashion.

In a further refinement, which also forms an invention per se, a distance control value and an angle control value are determined and provided by means of the at least two distance sensors in order to guide the linear range of activity parallel to the workpiece surface.

Alternatively, a number of distance control values could be used to this end. By contrast, the preferred refinement enables a very simple and cost-effective adjusting of a defined distance along a linear effective range.

In a further refinement, at least three distance sensors are provided that each run ahead of the linear range of activity with a defined lead, with each distance sensor supplying a distance value, and wherein the distance control value and the angle control value are determined as a function of the at least three distance values.

This refinement enables a very uniform and accurate adjusting of the defined distance over the entire course of the linear range of activity. In addition, it can be implemented very cost-effectively, as is demonstrated below in connection with a preferred exemplary embodiment.

It goes without saying that the features mentioned above and those still to be explained below can be used not only in the respectively specified combination, but also in other combinations or on their own without departing from the scope of the present invention.

Exemplary embodiments of the invention are illustrated in the drawing and explained in more detail in the following description. In the drawing:

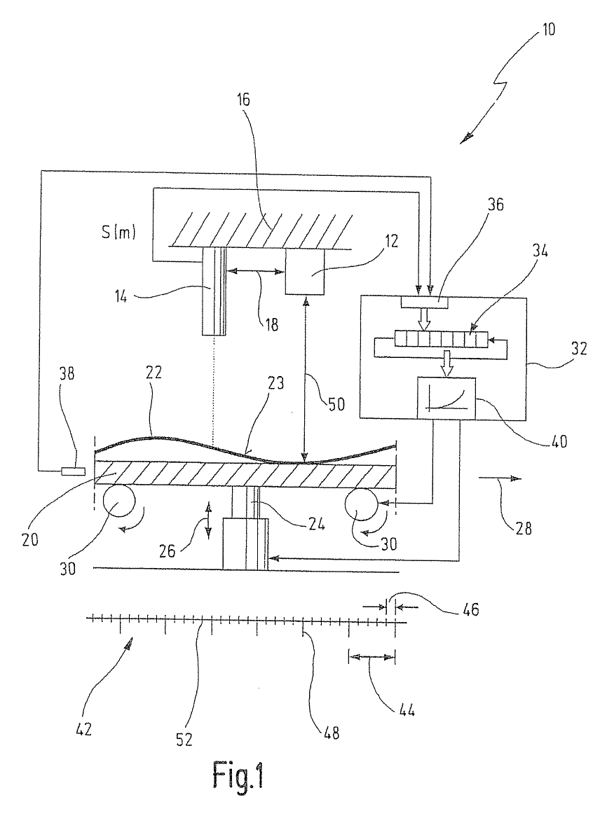

FIG. 1 shows a simplified schematic of an exemplary embodiment of the novel arrangement,

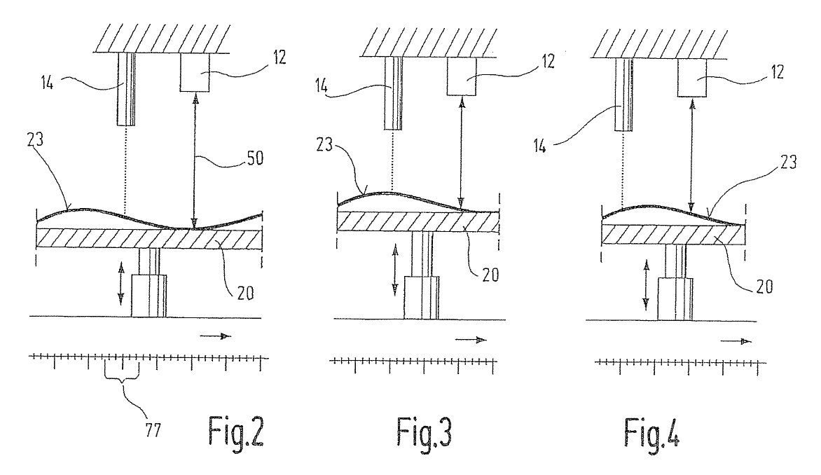

FIGS. 2-4 show the arrangement from FIG. 1 in three different operating positions,

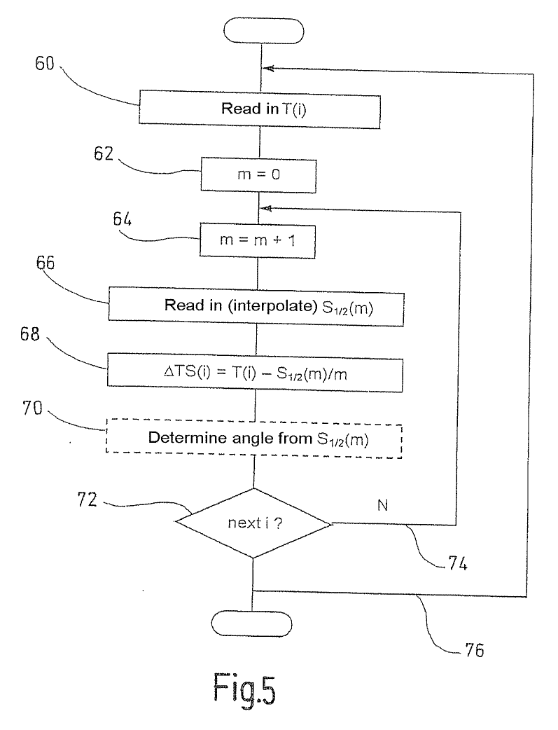

FIG. 5 shows a simplified flowchart that illustrates how distance values are read in, in accordance with an exemplary embodiment of the invention,

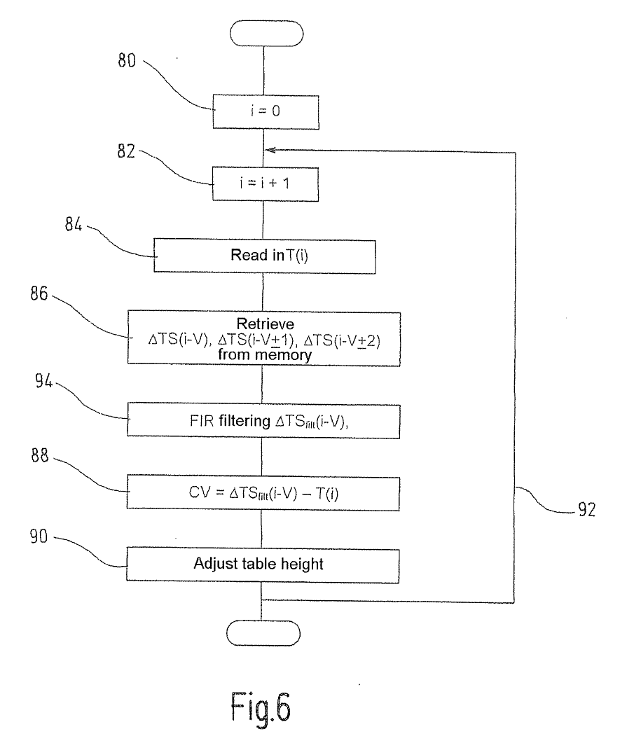

FIG. 6 shows a simplified flowchart for further illustration of an exemplary embodiment of the invention,

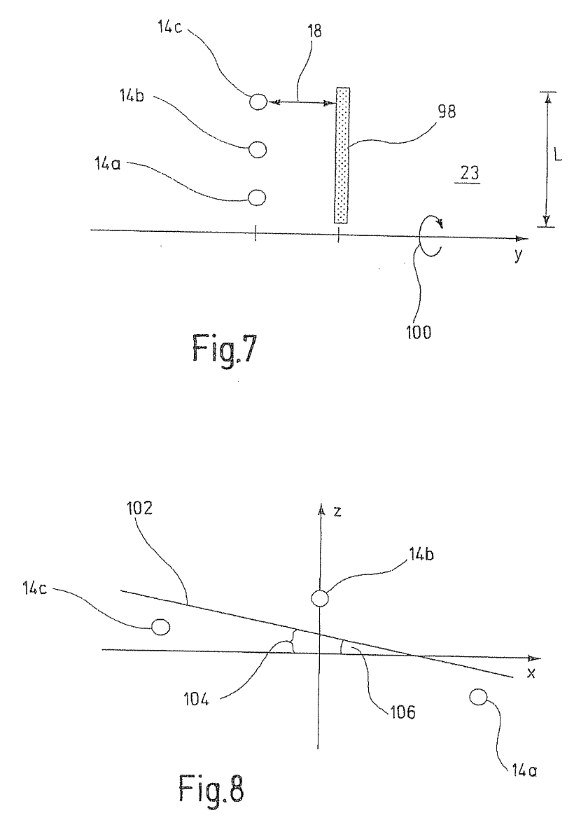

FIG. 7 shows a schematic of an arrangement in the case of which the machine part has a linear range of activity on the workpiece surface, and

FIG. 8 shows a graph illustrating a preferred exemplary embodiment of the invention given an arrangement in accordance with FIG. 7.

An exemplary embodiment of the novel arrangement is denoted in its entirety by reference numeral 10 in FIG. 1. The arrangement 10 includes a machine part 12 and at least one distance sensor 14 which are arranged here jointly on a support 16. The distance sensor 14 is fastened on the support 16, with a lateral offset 18 from the machine part 12. The offset 18 is the lead by which the distance sensor 14 runs ahead of the machine part 12 when the support 16 is moved relative to a workpiece.

The reference numeral 20 denotes a table on which a workpiece 22 is arranged. The workpiece 22 can be, for example, a multilayer element whose surface is to be heated in a specific way in order to interconnect the near-surface layers. Such an application arises, in particular when producing liquid crystal displays (LCDs). In this preferred case, the machine part 12 is a laser that must be guided at an optimum focal distance from the workpiece surface 23 of the workpiece 22.

The height of the table 20 can be adjusted in this exemplary embodiment as is indicated by a hydraulic cylinder 24 and an arrow 26. Alternatively, or as a supplement hereto, the height of the support 16 could also be adjustable. Moreover, in this exemplary embodiment the table 20 can be moved in the direction of the arrow 28, thus producing a relative movement of the machine part 12 over the workpiece surface 23 in an opposite direction. The table 20 is therefore provided with a drive 30, which is illustrated here only schematically. Alternatively, or as a supplement hereto, it could also be possible to move the support 16 parallel to the arrow 28. The arrow 28 therefore specifies a general movement axis of the arrangement 10. This movement axis is also denoted below as Y axis.

The reference numeral 32 denotes a control unit that controls the movement of the table 20. The control unit 32 includes a memory 34 that is designed in this exemplary embodiment as a rolling memory. The memory 34 has a number of memory locations that are written to and read from cyclically in sequence. The oldest entry in the memory locations is respectively overwritten by the newest entry. The number of memory positions corresponds to the lead 18 between the distance sensor 14 and the machine part 12. It is at least so large that a distance value read in by the distance sensor 14 at a position Y=Y₀ (or a control value based thereon) is still present in the memory 34 when the machine part 12 reaches the position Y₀.

The control unit 32 has an input circuit 36. The input circuit 36 serves to record the distance values or distance signals of the distance sensor 14. Moreover, the input circuit 36 is fed by the output signal of a sensor 38 by means of which the height of the table 20 can be determined in the direction of the arrow 26 (Z axis). The input circuit 36 is designed for conditioning the received distance and height values such that they can be stored at a memory position of the memory 34. It goes without saying that this memory position can comprise a number of bytes in order to record the data. The number of the memory positions preferably corresponds in the rolling memory 34 to the number of Y-positions that can be resolved along the movement axis 28 over the lead 18.

On the output side, the control unit 32 has a controller 40 that serves for adjusting the height and the feed movement of the table 20. In a preferred exemplary embodiment, the controller 40 has a nonlinear controller gain, which is illustrated by the characteristic curve in FIG. 1. It is preferably a PID controller that is used, but it may also be a PI, a PD or a P controller. Moreover, it is particularly preferred when the controller 40 does not react in the event of very small system deviations. In other words, the controller 40 does not begin to correct the system deviation until there is a system deviation lying above a defined threshold value.

A scale 42 is illustrated below the arrangement 10. The scale 42 has a relatively coarse grid 44 and a finer grid 46. The relatively coarse grid 44 here specifies the Y-positions, which can be resolved in the movement direction 28 of the table 20. In the preferred exemplary embodiment, a control value is determined for each Y-position 48, the height of the table 20 and thus the distance 50 between the machine part 12 and the workpiece 23 is adjusted by means of said control value.

The grid 46 has grid spacings that are smaller than the grid spacings of the grid 44. Each grid point 52 of the grid 46 denotes a measurement position at which the distance sensor 14 measures the distance from the workpiece surface 23. These measured values are transmitted as distance values to the control unit 32, and they are not always identical to the distance 50 between the machine part 12 and the workpiece surface 23, as follows from the illustration in FIG. 1.

The relatively high grid density of the first grid 46 can also be a consequence of the fact that the distance sensor 14 determines the distance from the workpiece surface 23 continuously, wherein the continuous distance values are then preferably converted by an A/D converter, in order to obtain digital distance values.

The grid points of the first grid 46 and of the second grid 44 coincide at the Y-positions of the second grid 44 which are illustrated with reference numeral 48. The Y-positions (grid points) 48 of the second grid are read in here, for example, by means of a glass scale in a way as is known per se from machine tools and coordinate measuring machines. The resolution of the glass scale determines the grid spacings 44 of the second grid.

FIGS. 2 to 4 show the arrangement 10 in three operating positions, with identical reference symbols denoting the same elements as before.

It may be assumed that the table 20 in FIG. 2 is located at the position Y=Y₀, and that the lead between the distance sensor and the machine part is 50 mm. The height of the table 20 may be, for example, 5 μm with reference to a table zero point (not illustrated here). The distance sensor 14 measures, for example, a distance value of −3 μm relative to the workpiece surface 23. The value of −3 μm is referred to a zero point (not illustrated here). The zero points for the table 20 and the distance sensor 14 are selected such that the workpiece surface 23 is located at the focus of the machine part 12 when both values equal zero.

It may be assumed in FIG. 3 that the table 20 is located at a Y-position of Y=25 mm. In other words, table 20 has moved to the right by 25 mm. The distance sensor 14 supplies, for example, a distance value of 2 μm, while the height of the table 20 may be 7 μm here.

It may be assumed in the operating position in accordance with FIG. 4 that the table 20 is at y=50 mm. The height of the table 20 is 6 μm, while the measured distance value of sensor 14 may (accidently) be 2 μm. All specified values are summarized again in the following table:

| Y- | Table | Distance | ΔTS = | CV = ΔTS(i) − |
|---|---|---|---|---|
| position | height T | value S | T − S | T(i + V) |
| 0 | 5 μm | −3 μm | 8 μm | ? |
| 25 | 7 μm | 2 μm | 5 μm | ? |
| 50 | 6 μm | 2 μm | 4 μm | 8 μm − 6 μm = |
| | | | | −2 μm |

The rows of the table correspond to the memory positions in the rolling memory 34. Each Y-position is assigned a memory position=table row. Stored in each memory position are the table height T(y) and the distance values S(m). In this exemplary embodiment of the invention, the control operation cannot begin until the table 20 has reached the Y-position Y=50 mm. Available at this instant are both the current table height T(50 mm)=6 μm, and the information as to which table height T(0)=5 μm and which distance value S(0)=−3 μm were present when the distance sensor 14 had been located at the Y-position y=0. In other words, the machine part 12 must initially be moved by the lead 18 in relation to the workpiece surface 23 so that the control process can start.

In accordance with the fifth column, it is now possible to determine the instantaneous system deviation CV from the difference between the two table heights at the Y-positions y=0 and y=50 and the distance value S(0) at the Y-position y=0. In the exemplary embodiment illustrated, the result is a system deviation of −2 μm with respect to the reference zero point. This system deviation is fed to the controller 40 in order to correct for the system deviation. In other words, the controller 40 controls the table height such that the system deviation of −2 μm vanishes. This operation is repeated cyclically for each further Y-position.

FIG. 5 shows a preferred exemplary embodiment for reading the table heights and distance values into the memory 34.

In accordance with step 60, the height T(i) of the table 20 at the Y-position y=i is read in first. A counter that corresponds to the grid spacings 46 is set to zero in step 62. The counter m=m+1 is incremented in step 64. The distance value S(m) is then read in in accordance with step 66. The difference ΔTS(i) between the table height T(i) read in and the distance value S(m) is determined in accordance with step 68. This difference is stored in memory 34 in accordance with the table illustrated above. Furthermore the table height T(i) is stored in relation to the difference value. A determination of an angle can be performed in accordance with step 70, as is explained in more detail below. An inquiry as to whether the next Y-position has already been reached is performed in accordance with step 72. If this is not the case, then method returns to step 64 in accordance with step 74. A further distance value is read in for the grid position (measurement position) m=m+1. Since the Y-position y=i is the same (or at least the measurement resolution indicates no change), the distance values S(m) and S(m+1) are averaged and subtracted in step 68 from the table height T(i). This produces a smoothing of the distance values that leads to a smoother and more accurate control response.

Only when the interrogation 72 indicates that the next Y-position y=i+1 has been reached, the counting variable m is set to zero again. The distance values that are assigned to the Y-position y=i+1 are now read in, averaged and stored.

With this method, the distance values at the measurement positions m (recorded in the grid 46) each are assigned to that Y-position (=actuating position) to which they lie closest. This is symbolically indicated in FIG. 2 by reference numeral 77.

It is assumed in the exemplary embodiments thus far that the grid spacings 46 which specify the measurement positions of the distance sensor 14 are smaller than the grid spacings 44 which specify the Y-positions of the table 20. The opposite case is also possible. It can occur here that a new Y-position is read in but no new distance value is available. In contrast from the previous explanation, no distance value is then read in in step 66, but a distance value is formed by extrapolation—or in the case of a later post-processing—by interpolation. In this case, as well, at least one distance value is thus assigned to each Y-position.

FIG. 6 illustrates the control operation for adjusting the table height by means of a simplified flowchart. Here, as well, a counting variable that specifies the Y-position of the table 20 is first set at zero in step 80. The counting variable i is incremented in step 82. The actual table height T(i) is read in step 84. In the table given above, this table height was, for example, 6 μm (see lowermost table row).

The difference ΔTS(i-V) between the table height and distance value at the Y-position y=i−V is retrieved from the memory 34 in step 86. Subsequently, the system deviation CV is determined in step 88 from the difference between the values read in:

CV=ΔTS(i−V)−T(i).

The system deviation CV is fed in step 90 to the controller 40, which adjusts the table height correspondingly. Subsequently, a further program run is performed for the next actuation position i=i+1 in accordance with step 90.

The flowchart in FIG. 6 shows a modification of this preferred method sequence. Here, not only the difference ΔTS(i−V) is retrieved from the memory 34. Rather, the corresponding values ΔTS(i±1−V), ΔTS(i±2−V) of the neighboring Y-positions are also read out from the memory. Subsequently, all values are combined with one another in a FIR filtering (Finite Impulse Response filtering) in order to obtain a filtered value ΔTS_{filt}(i−V). The filtered value is then used in step 88 in order to determine the system deviation CV. The FIR filtering leads to a smoother control response. Since it is also possible to incorporate “future” Y-positions in the filtering as a result of the distance sensor 14 running ahead, a FIR filter that is true to phase and enables a particularly high control accuracy is obtained.

FIG. 7 shows a schematic plan view of the workpiece surface 23 in a preferred exemplary embodiment. In this exemplary embodiment, the machine part 12 is a laser that generates a laser line 98 on the workpiece surface 23, which laser line is intended to be kept in focus over the entire length L by means of the novel method. A preferred exemplary embodiment is the heating of a workpiece surface that passes through below the laser line 98 in the direction of the Y-axis. The laser line 98 runs transverse to the movement direction of the workpiece surface 23. In the exemplary embodiment illustrated in FIG. 7, the laser line 98 is aligned in a fashion orthogonal to the Y-axis.

In the preferred exemplary embodiment, three distance sensors 14a, 14b, 14c run ahead of the laser line 98. The distance sensors 14a, 14b, 14c are arranged next to one another and have the same lead 18 relative to the machine part 12 or the laser line 98. By means of this arrangement, it is possible to determine a rolling movement 100 of the workpiece surface 23 above the Y axis. In this case, the arrangement 10 is preferably designed such that the table 20 can be pivoted about the Y axis such that the laser line 98 can be focused on to the workpiece surface 23 over the entire length.

In a particularly preferred exemplary embodiment, the workpiece surface 23 is adjusted around the Y axis by using the distance values from at least two distance sensors 14a, 14b, 14c to determine a distance control value and an angle control value. This is shown in step 70 in the flowchart of FIG. 5. Indices “1” and “2” denote the at least two measured distance values of the at least two distance sensors 14a, 14b, 14c.

In a further preferred exemplary embodiment, it is contemplated that an angle offset value and a distance offset value can be entered into the control unit 32. The controller 40 considers the offset values during adjusting of the table position. By inputting suitable offset values, it is possible to specifically remove the laser line 98 from the focus in order, for example, to carry out test series. Inputting an angle and distance offset values of zero results in keeping the laser line 98 in focus over the entire length.

It would be sufficient to have two distance values from two distance sensors 14a, 14c for the focus control of the laser line 98. The use of three or more distance sensors 14a, 14b, 14c leads to a higher number of distance values than required for determining the two control variables of distance and angle.

In other words, the system of distance and angle control is overdefined with three and more distance sensors. The overdefinition can, however, be advantageously used when a mean straight line is determined that is then used to determine the system deviations. Such a mean straight line is illustrated in FIG. 8 by reference numeral 102. In this case, the straight line 102 is a mean straight line in accordance with the method of least squares between the distance values of the distance sensors 14a, 14b, 14c. The offset 104 of the straight line 102 (the point of intersection of the straight line 102 with the Z axis) can advantageously be used as system deviation for the distance control. The gradient of the straight line, that is to say the angle 106, then serves as a system deviation for adjusting the table inclination around the Y axis.

It is contemplated in further exemplary embodiments (not illustrated here) that the controller 40 is limited to the maximum permissible dynamics (maximum acceleration and maximum speed) of the arrangement 10. Damage to the arrangement 10 is thereby avoided in the case of large system deviations.

1. A method for guiding a machine part (12) along a defined movement path (28) over a workpiece surface (23), the machine part (12) being held along the movement path at a defined distance (50) from the workpiece surface (23), comprising the steps of:
providing a distance sensor (14) that runs ahead of the machine part (12) along the movement path (28) with a defined lead (18),
determining a plurality of distance values (S(m)) between the distance sensor (14) and the workpiece surface (23) along the movement path (28),
determining a plurality of control values (ΔTS(i)) for adjusting the defined distance (50) as a function of the first distance values (S(m)), and
moving the machine part (12) along the movement path (28) and repeatedly adjusting the defined distance (50) by means of the control values (ΔTS(i)),
characterized in that
the distance values (S(m)) are determined at a plurality of measurement positions (m) that are distributed along the movement path (28) with a first grid spacing (46), and
the control values (ΔTS(i)) are assigned to a plurality of actuating positions (i) that are distributed along the movement path (28) with a second grid spacing (44),
wherein the first and the second grid spacings (46, 44) are different.

2-15. (canceled)
